(19) United States
(12) Patent Application Publication
(10) Pub. No.: US 2008/0282234 A1
(43) Pub. Date: Nov. 13, 2008

(54) DYNAMIC EMULATION MODE SWITCHING

(75) Inventors: Seiji Yanagida, Toride-City (JP); Gary A. Cooper, Pittsburgh, PA (US); Takeshi Hiraoka, Tsukuba City (JP)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/116,756

(22) Filed: May 7, 2008

Related U.S. Application Data
(60) Provisional application No. 60/927,951, filed on May 7, 2007.

(51) Int. Cl. G06F 9/44

(52) U.S. Cl. 717/129

(57) ABSTRACT

In at least some embodiments, a computing system includes a processor and a debug module coupled to the processor. The debug module controls an emulation environment for debugging code, the emulation environment having a first mode that enables time-critical code to execute while non-time-critical code is halted and a second mode that halts execution of both time-critical code and non-time-critical code. The computing system also includes switch logic in communication with the processor and the debug module, wherein the switch logic enables dynamic switching between the first and second modes.

### CROSS-REFERENCE TO RELATED APPLICATIONS

This application is a non-provisional application claiming priority to U.S. Pat. App. Ser. No. 60/927,951, entitled “Automatic emulation mode switching feature”, filed on May 7, 2007. The above-referenced application is hereby incorporated herein by reference.

### FIELD OF THE INVENTION

The present disclosure is directed to communication and control systems, and more particularly, but not by way of limitation, to emulation environments for debugging code.

### BACKGROUND

To facilitate debugging executable code, emulation environments have been developed that enable a user to suspend program execution at various break events (e.g., software breakpoint instructions, specified program accesses, data accesses, analysis breakpoints, or watchpoints). To debug code, a user can step through each instruction or run a series of instructions (e.g., to the next break event). Some emulation environments support different modes. For example, the different modes may enable a user to perform different types of debug activities. Switching between different modes in an emulation environment can be problematic.

### SUMMARY

In at least some embodiments, a computing system comprises a processor and a debug module coupled to the processor. The debug module controls an emulation environment for debugging code, the emulation environment having a first mode that enables time-critical code to execute while non-time-critical code is halted and a second mode that halts execution of both time-critical code and non-time-critical code. The computing system also comprises switch logic in communication with the processor and the debug module, wherein the switch logic enables dynamic switching between the first and second modes.

In at least some embodiments, a method for a debugger comprises providing a first mode that executes time-critical code while non-time-critical code is halted. The method further comprises providing a second mode that halts execution of both time-critical code and non-time-critical code. The method further comprises dynamically switching between the first and second modes.

In at least some embodiments, a system comprises a processor and means for debugging code. The means for debugging code supports a first mode that enables time-critical code to execute while non-time-critical code is halted and a second mode that halts execution of both time-critical code and non-time-critical code. The system also comprises means for dynamically switching between the first and second modes.

### BRIEF DESCRIPTION OF THE DRAWINGS

For a detailed description of various embodiments of the invention, reference will now be made to the accompanying drawings in which:

FIG. 1 shows a system in accordance with embodiments of the disclosure;

FIG. 2 shows a computing system in accordance with embodiments of the disclosure;

FIG. 3 shows switch logic in accordance with embodiments of the disclosure;

FIG. 4 shows a timing diagram in accordance with embodiments of the disclosure;

FIG. 5 shows another timing diagram in accordance with embodiments of the disclosure;

FIG. 6 shows another timing diagram in accordance with embodiments of the disclosure;

FIG. 7 illustrates a method in accordance with embodiments of the disclosure; and

FIG. 8 illustrates another method in accordance with embodiments of the disclosure.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection

### DETAILED DESCRIPTION

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

Embodiments of the disclosure are directed to devices having an Emulation Environment (EE) that supports multiple modes. In at least some embodiments, the EE has a first mode (referred to herein as a “stop-mode”) that halts execution of all code and a second mode (referred to herein as a “real-time mode”) that allows selected interrupt service routines (ISRs) to be performed while execution of background code is halted. “Background code” refers to the main body of code which is generally not as time-critical as the interrupt routines which service, for example, motor controls or high-speed timers. In other words, the real-time mode provides for the debug of code that interacts with interrupts that cannot be disabled whereas the stop-mode provides complete control of program execution, allowing for the disabling of all interrupts (including resets and non-maskable interrupts). Both EE modes can suspend program execution at break events such as software breakpoint instructions, specified program accesses or data accesses (e.g., analysis breakpoints or watchpoints), and upon request from the host or external hardware. In accordance with embodiments, a user is able to dynamically switch (back and forth) between the stop-mode and the real-time mode.

In at least some embodiments, suspending program execution causes instruction decoding to stop (similar to an IDLE instruction). In a pipeline embodiment, suspension of execution causes instruction decoding to stop while the pipeline flushes (all current pipeline activity completes). Interrupts can restart execution, but after the interrupt service routine is complete, the device returns to a suspended state. When suspended, interrupt control signals are employed to determine which interrupts to service (i.e., to identify time-critical interrupts).

During the stop-mode and/or the real-time mode, an EE user interface (EEUI) is provided to enable a user to debug code. The EEUI supports various commands such as a “run” command and a “step” command. The “run” command gives precedence to non-time-critical interrupts and resets over the execution of the next instruction. In contrast, the “step” command gives precedence to execution of the next instruction over non-time-critical interrupts and resets.

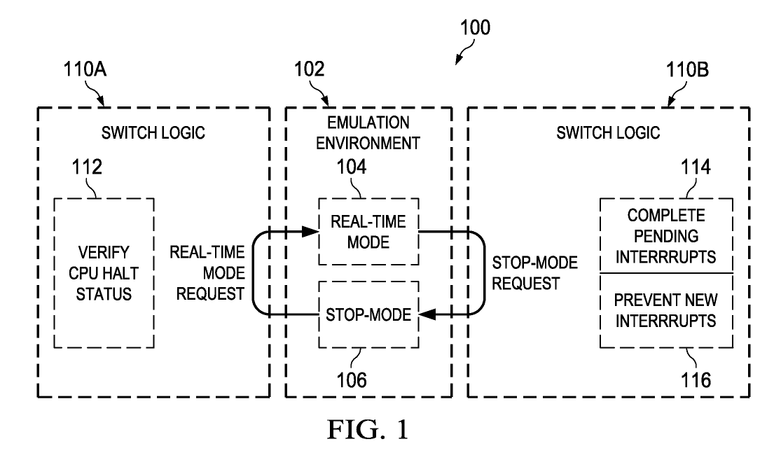

FIG. 1 shows a system 100 in accordance with embodiments of the disclosure. As shown, the system 100 comprises an EE 102 having a real-time mode 104 and a stop mode 106. The EE 102 is used, for example, to debug code. The real-time mode 104 distinguishes between time-critical code and non-time-critical code. For example, the real-time mode 104 may enable execution of time-critical code while non-time-critical code is halted. In this manner, the real-time mode 104 may be used to debug code that interacts with time-critical code (e.g., selected interrupts). In contrast, the stop mode 106 does not distinguish between time-critical code and non-time-critical code. In the stop mode 106, execution of both time-critical and non-time-critical code is halted. The stop-mode 106 provides complete control of program execution, including the disabling of time-critical code.

To dynamically switch back and forth between the real-time mode 104 and the stop mode 106, the system 100 employs switch logic 110A and 110B in communication with the emulation environment 102. The switch logic 110A and 110B represents hardware, firmware and/or software in communication with the emulation environment 102. As shown, the switch logic 110A comprises a “verify central processing unit (CPU) halt status” block (VCHS) 112. The VCHS block 112 ensures that a CPU has halted (e.g., a requested stop-mode has started) before entering the real-time mode 104.

The switch logic 110B also comprises a “complete pending interrupts” block (CPI) 114 and a “prevent new interrupts” block (PNI) 116. The CPI block 114 tracks whether a time-critical interrupt is received prior to a given stop-mode request (pending interrupts). In at least some embodiments, all pending time-critical interrupts are allowed to complete before switching to the stop-mode 106. Meanwhile, the PNI block 116 tracks whether a time-critical interrupt is received after the given stop-mode request (new interrupts). New time-critical interrupts not serviced, even if the switch to the stop-mode 106 is delayed to complete execution of pending time-critical interrupts or other delays. Any interrupt request received after the given stop-mode switch request will remain pending until execution resumes or the real-time mode is activated again.

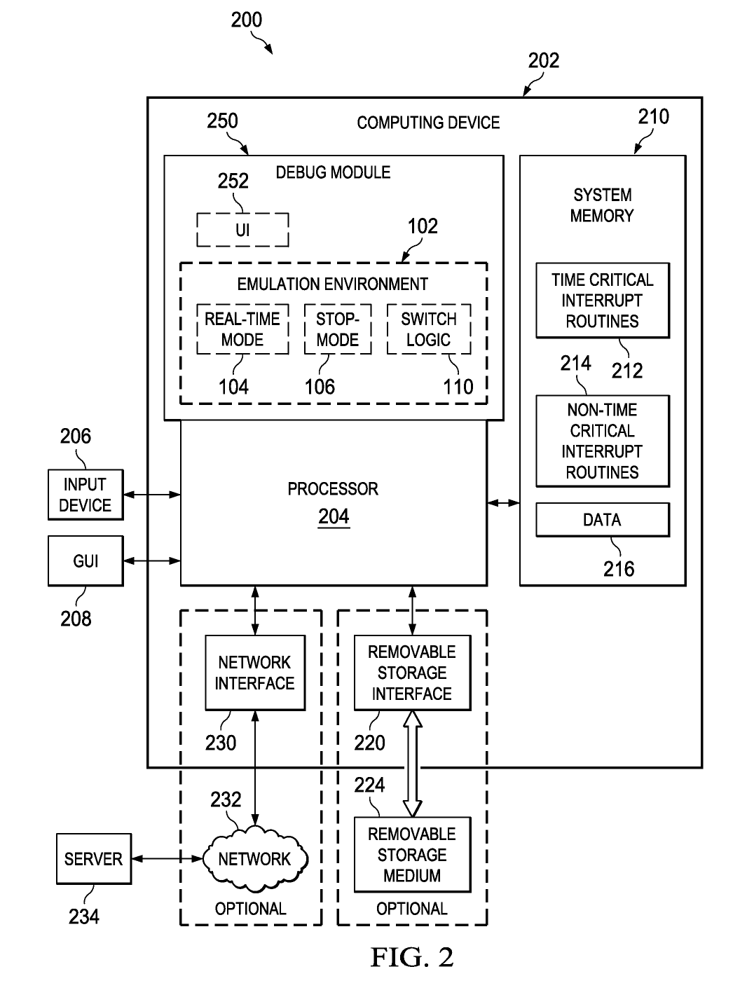

FIG. 2 shows a computing system 200 in accordance with embodiments of the disclosure. As shown, the computing system 200 comprises a computing device 202 (e.g., a desktop computer, a laptop computer, a server, a cell phone, a smart phone, a personal digital assistant (PDA) or other device) having at least one processor 204 and a system memory 210. The system memory 210 may be any suitable computer-readable medium which stores applications and/or instructions executable by the processor 204. For example, the system memory 210 may comprise volatile memory such as random access memory (RAM). Additionally or alternatively, the system memory 210 may comprise non-volatile memory such as a hard disk, a flash drive or an optical disk. The system memory 210 may store, for example, time-critical interrupt routines 212, non-time-critical interrupt routines 214 and data 216. In various embodiments, the time-critical interrupt routines 212, the non-time-critical interrupt routines 214 and/or the data 216 is accessed from a removable storage medium 224 (e.g., an optical disk or a flash drive) via an optional removable storage interface 220. Additionally or alternatively, the time-critical interrupt routines 212, the non-time-critical interrupt routines 214 and/or the data 216 are accessed from a server 234 on a network 232 via an optional network interface 230.

In at least some embodiments, the EE 102 is a component of a debug module 250 that is in communication with the processor 204 or that is part of processor 204. For example, in some embodiments, the debug module 250 is attached directly to a processor's pipeline. As shown, the emulation environment 102 provides the real-time mode 104, the stop-mode 106 and the switch logic 110 described previously. In alternative embodiments, the switch logic 110 is coupled to, but separate from, the emulation environment 102.

In at least some embodiments, the debug module 250 supports a user interface (UI) 252 that enables a user to enter (e.g., type) debug commands via an input device 206 coupled to the processor 204. The input device 206 represents, for example, a keyboard, a mouse and/or other devices that enable a user to interact with the computing device 202. In accordance with some embodiments, at least one corresponding user interface window may be displayed via a graphic user interface (GUI) 208 coupled to the processor 204. The user interface window may display information related to the real-time mode 104 and/or the stop-mode 106 described herein.

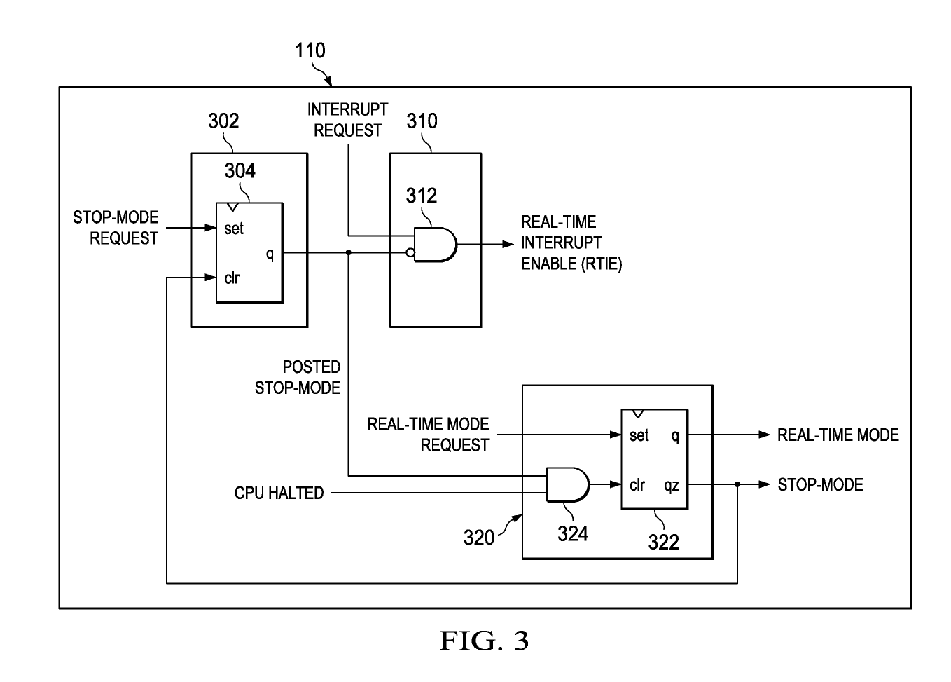

FIG. 3 shows switch logic 110 in accordance with embodiments of the disclosure. The switch logic 110 activates either the real-time mode 104 or the stop mode 106 based on various signals. As previously described, the switch logic 110 may ensure that a CPU has halted (e.g., a requested stop-mode has started) before switching from the stop-mode 106 to the real-time mode 104. Additionally, the switch logic 110 may allow pending time-critical interrupt routines 212 to complete before switching from the real-time mode 104 to the stop-mode 106. Also, the switch logic 110 may cause new time-critical interrupt routines 212 (received after a given stop-mode request) to not be serviced when switching from the real-time mode 104 to the stop-mode 106. In at least some embodiments, interrupt requests received after the stop-mode switch request will remain pending until processor execution resumes or the real-time mode is activated again.

In FIG. 3, the switch logic functions described above are performed by a stop-mode posting block 302 coupled to an interrupt handler block 310 and a mode generation block 320. Specifically, the stop-mode posting block 302 comprises a flip-flop 304 or other latching device that asserts a signal in response to receiving a stop-mode request. The output of the stop-mode posting block 302 is forwarded to the mode generation block 320, which selectively activates the real-time mode 104 or the stop-mode 106 based on a flip-flop 322 and an AND gate 324. Specifically, if a real-time mode request is received by the flip-flop 322, a real-time mode signal is output from the flip-flop 322 and the mode generation block 320 unless a CPU halted signal provided to the AND gate 324 indicates the CPU has not yet halted. Such a situation may occur if a real-time mode request is made shortly after a stop-mode request.

As shown, the interrupt handler block 310 also receives the output of the stop-mode posting block 302. If the stop-mode posting block 302 indicates that a stop-mode request has not been received, the interrupt handler block 310 outputs a real-time interrupt enable (RTIE) signal in response to receiving an interrupt request. In at least some embodiments, the RTIE signal enables time-critical interrupts to be executed during the real-time mode 104. If the stop-mode posting block 302 indicates that a stop-mode request has been received, the interrupt handler block 310 de-asserts the RTIE signal even if additional interrupt requests are received. In this manner, interrupt requests received after a stop-mode request is received are ignored. As shown, the functions of the interrupt handler block 310 may be performed by an AND gate 312 that receives interrupt requests at one input and that receives the inverted output of the stop-mode posting block 302 at the other input. In FIG. 3, the CPU halted signal will not be asserted until all pending interrupts have been completed. Thus, the switch from the real-time mode 104 to the stop-mode 106 will not occur until all pending interrupts have been completed.

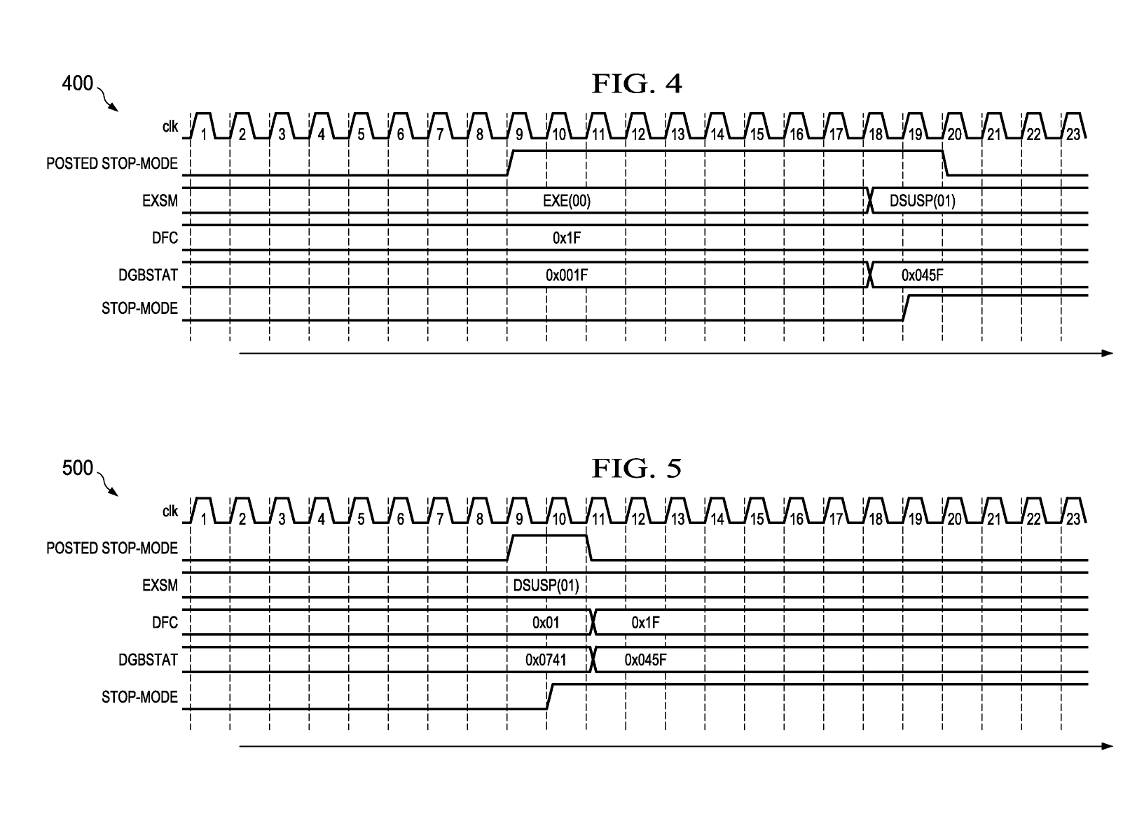

FIG. 4 shows a timing diagram 400 in accordance with embodiments of the disclosure. In the timing diagram 400, the EE 102 is in the real-time mode 104 and the processor 204 is in a normal execution state as part of the real-time mode 104. As shown, a stop-mode request is made when the “posted stop-mode” signal is asserted at clock cycle 9. The “posted stop-mode” signal remains asserted until a halt event has been acknowledged by the processor 204. In the timing diagram 400, the state switches of the EXSM and DBGSTAT signals at clock cycle 18 correspond to the processor 204 acknowledging a halt event. Once the halt event is acknowledged, the stop-mode begins at clock cycle 19 and the stop-mode request can be de-asserted at clock cycle 20.

Although various signal names shown in FIG. 4 are processor-specific (e.g., EXSM, DFC, DGBSTAT), embodiments are not to be limited to a particular processor. Rather, the timing diagram 400 illustrates that if a stop-mode request is made during the real-time mode 104 with the processor 204 in a normal execution state, the stop-mode request remains pending until a halt event occurs. Once a halt event is acknowledged by the processor 204, the stop-mode can begin and the stop-mode request is de-asserted. For more information regarding EEs and processors relevant to some embodiments, reference may be had to U.S. Pat. No. 6,553,513, entitled “Emulation suspend mode with differing response to different classes of interrupts”, U.S. Pat. No. 6,567,933, entitled “Emulation suspension mode with stop mode extension”, U.S. Pat. No. 6,564,339, entitled “Emulation suspension mode handing multiple stops and starts”, and U.S. Pat. No. 6,557,116, entitled “Emulation suspension mode with frame controlled resource access”. The above-mentioned patents are hereby incorporated herein by reference.

FIG. 5 shows another timing diagram 500 in accordance with embodiments of the disclosure. In the timing diagram 500, the EE 102 is in the real-time mode 104 and the processor 204 is in a halted execution state as part of the real-time mode 104. The signal names in the timing diagram 500 are the same as those used for the timing diagram 400 of FIG. 4 and thus the same discussion applies. As shown, a stop-mode request is made when the “posted stop-mode” signal is asserted at clock cycle 9. The “posted stop-mode” signal remains asserted until after the stop-mode begins at clock cycle 10. The timing diagram 500 illustrates that if a stop-mode request is made during the real-time mode 104 with the processor 204 in a halted state, the stop-mode can begin without delay (e.g., during the next clock cycle).

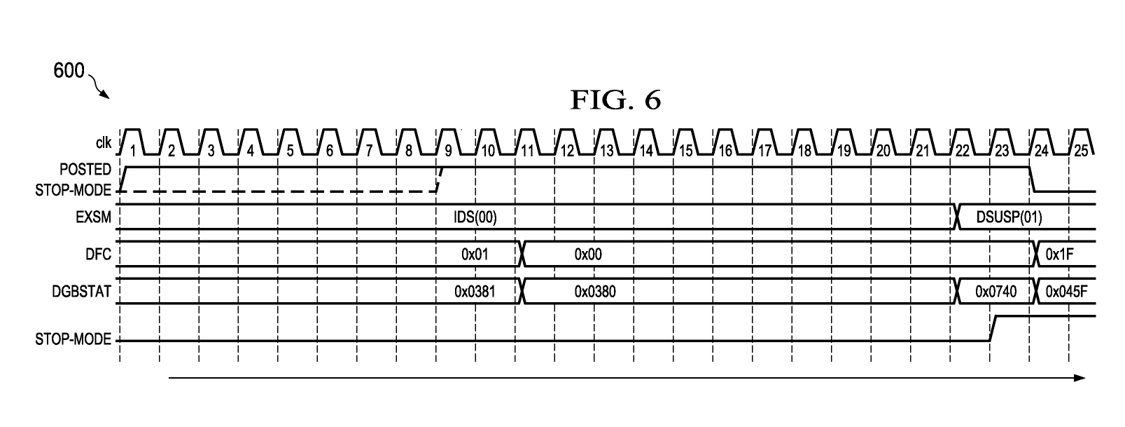

FIG. 6 shows another timing diagram 600 in accordance with embodiments of the disclosure. In the timing diagram 600, the EE 102 is in the real-time mode 104 and the processor 204 is executing time-critical interrupts. The signal names in the timing diagram 600 are the same as those used for the timing diagram 400 of FIG. 4 and thus the same discussion applies. As shown, a stop-mode request is made when the “posted stop-mode” signal is asserted at clock cycle 1. The “posted stop-mode” signal remains asserted until after the stop-mode begins at clock cycle 23. The stop-mode is delayed until two time-critical interrupts are completed as indicated by the state switches of EXSM and DBGSTAT at clock cycle 22. Once the stop-mode begins, the stop-mode request is de-asserted at clock cycle 24. The timing diagram 600 illustrates that if a stop-mode request is made during the real-time mode 104 with the processor 204 executing time-critical interrupts, the stop-mode is delayed until all pending interrupts are completed. However, new interrupts (received after the stop-mode request) are ignored.

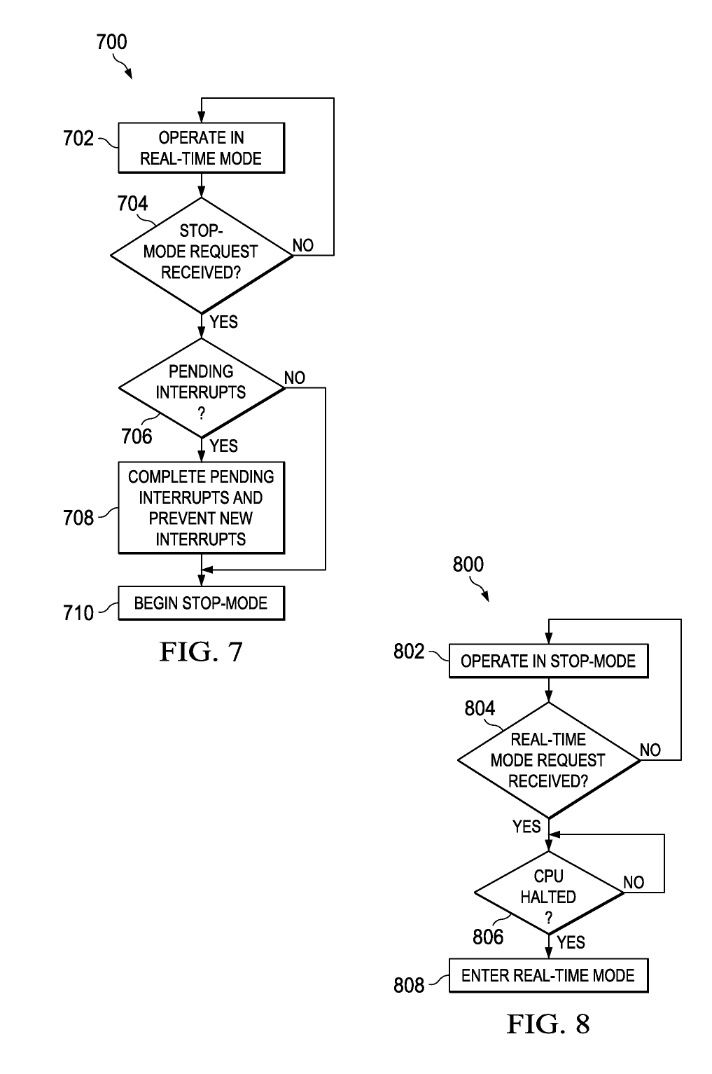

FIG. 7 illustrates a method 700 in accordance with embodiments of the disclosure. As shown, the method 700 comprises operating in the real-time mode (block 702) until a stop-mode request is received (determination block 704). If a stop-mode request is received (determination block 704), the method 700 determines if there are any pending interrupts that should be completed prior to entering the stop-mode (determination block 706). If there are pending interrupts (determination block 706), the pending interrupts are completed and new interrupts are prevented (block 708). If there are not pending interrupts (determination block 706) or the pending interrupts have been completed (block 708), the method 700 begins the stop-mode. In at least some embodiments, the method 700 may further comprises determining, during the real-time mode, if a processor is in a normal execution state and waiting for a halt event before transitioning to the stop-mode. Additionally or alternatively, the method 700 may further comprise determining, during the real-time mode, if a processor is in a halted execution state and transitioning to the stop-mode without delay.

FIG. 8 illustrates another method 800 in accordance with embodiments of the disclosure. As shown, the method 800 comprises operating in the stop-mode (block 802) until a real-time mode request is received (determination block 804). Upon receiving a real-time request (determination block 804), the method 800 verifies that a CPU has halted (determination block 806) before entering the real-time mode.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A computing system, comprising:
a processor;
a debug module coupled to said processor, wherein the debug module controls an emulation environment for debugging code, the emulation environment having a first mode that enables time-critical code to execute while non-time-critical code is halted and a second mode that halts execution of both time-critical code and non-time-critical code; and
switch logic in communication with the processor and the debug module, wherein the switch logic enables dynamic switching between the first and second modes.

2. The computing system of claim 1 wherein, upon receiving a first-to-second mode switch request, the switch logic allows pending time-critical interrupts to complete before switching from the first mode to the second mode.

3. The computing system of claim 1 wherein, upon receiving a first-to-second mode switch request, the switch logic ignores new time-critical interrupts while switching from the first mode to the second mode.

4. The computing system of claim 1 wherein, upon receiving a first-to-second mode switch request, the switch logic determines whether the processor is in a normal execution state and delays switching from the first mode to the second mode until a halt event is acknowledged by the processor.

5. The computing system of claim 1 wherein, upon receiving a first-to-second mode switch request, the switch logic determines whether the processor is in a halted state and, if so, switches from the first mode to the second mode without delay.

6. The computing system of claim 1 wherein, upon receiving a second-to-first mode switch request, the switch logic verifies a processor halt status prior to switching from the second mode to the first mode.

7. The computing system of claim 1 wherein the switch logic selectively causes the emulation environment to operate in the first mode or the second mode based on a first mode request signal, a second mode request signal, an interrupt request signal and a processor halted signal.

8. The computing system of claim 1 wherein the switch logic is separate from the emulation environment.

9. A method for a debugger, comprising:
providing a first mode that executes time-critical code while non-time-critical code is halted;
providing a second mode that halts execution of both time-critical code and non-time-critical code; and
dynamically switching between the first and second modes.

10. The method of claim 9 further comprising detecting a request to switch from the first mode to the second mode.

11. The method of claim 10 further comprising, during the first mode, determining if a processor is halted and, if so, entering the second mode without delay in response to the request.

12. The method of claim 10 further comprising, during the first mode, determining if a processor is in a normal execution state and, if so, entering the second mode after the processor acknowledges a halt event.

13. The method of claim 10 further comprising, during the first mode, determining if a processor is executing a time-critical interrupt and, if so, entering the second mode after the time-critical interrupt is complete.

14. The method of claim 10 further comprising, during the first mode, ignoring time-critical interrupts received after the request.

15. The method of claim 9 further comprising detecting a request to switch from the second mode to the first mode.

16. The method of claim 15 further comprising verifying that a processor is in a halted state before switching from the second mode to the first mode.

17. The method of claim 9 wherein dynamically switching between the first and second modes is based on a first mode request signal, a second mode request signal, an interrupt request signal and a processor halted signal.

18. A system, comprising:
a processor;
means for debugging code coupled to the processor, the means for debugging code supports a first mode that enables time-critical code to execute while non-time-critical code is halted and a second mode that halts execution of both time-critical code and non-time-critical code; and
means for dynamically switching between the first and second modes.

19. The system of claim 18 wherein said means for dynamically switching between the first and second modes comprises means for handling interrupts received before and after a first-to-second mode switch request.

20. The system of claim 18 wherein said means for dynamically switching between the first and second modes comprises means for delaying a switch until the processor acknowledges a halt event.
